(19) United States
(12) Patent Application Publication
(10) Pub. No.: US 2004/0083135 A1
(43) Pub. Date: Apr. 29, 2004

(54) Electronic catalogue

(76) Inventor: Bang Thinh Chau, Maroubra (AU)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/257,310

(22) PCT Filed: Apr. 10, 2001
(86) PCT No.: PCT/AU01/00400

(30) Foreign Application Priority Data
Apr. 10, 2000 (AU) PR 0969

(51) Int. Cl. G06F 17/60

(52) U.S. Cl. 705/26

(57) ABSTRACT

A method of defining the properties of items in an electronic catalogue, the method comprising the steps of associating at least one of a plurality of property set identifiers with each item, wherein each property set identifier is in turn associated with a set of properties; and defining each item utilising the set of properties associated with the property set identifier associated with each item.

### FIELD OF THE INVENTION

The present invention relates broadly to data (content) management and integration, and particularly, but not exclusively to an electronic catalogue and a method of defining the properties of items in an electronic catalogue. A set of properties used to define a group of items is sometimes referred to as an “ontology”. The present invention will be described herein with reference to an electronic catalogue for goods. However, it will be appreciated that the present invention is not limited to the exact nature of the electronic catalogue. Rather, it could include any form of electronic catalogue, e.g. used to incorporate services, electronic documents or the content of web sites on the Internet. Therefore, the term “item” is intended to encompass any type of data entity within such an electronic catalogue.

### BACKGROUND OF THE INVENTION

Presently, electronic catalogues are maintained using a hard coded set of properties for defining the items contained therein.

As shown in FIG. 1, for a particular electronic catalogue the data would be maintained in a table structure 10 comprising a set of hard coded properties in a heading row 12 of the structure 10. The ontology of items (e.g. item abc) in such a catalogue is fixed. In FIG. 1, as is typically the case for standard databases, the heading row 12 will include a item id property 12A and a plurality of properties or attributes 12B, 12C, etc. The item id 12A column will include values identifying the item, e.g. abc and the item columns 12B, 12C, etc, will include fields storing values for particular property of the item e.g. values for the property of the item abc are 123, xyz, etc.

Such prior art electronic catalogues have the disadvantage that whenever an addition of a new property to the column 12 is intended, the entire content of the database table has to be restructured in that a new property column needs to be hard-coded and the values associated with the added property will have to be entered for each individual product-item in the structure 10. The program code will also need to be modified to access the new database table structure incorporating the new property column. That is, to extend or change the ontology of an item requires reprogramming of traditional databases and the software associated with them.

Furthermore, such electronic catalogues have the disadvantage that the set of properties 12 would have to be chosen to be suitable for all of the product-items in the catalogue. This can result in deficient definition of property details where certain properties would only be suitable for certain of the product-items, and therefore were not included in the generic set of properties.

Further, in traditional business systems, the ontology of a item includes information about the items taxonomy (data identifying how products are classified/categorised/grouped). That is, the data elements that define an tem include the data elements that define category codes, so the classification (or organisation or grouping) of items is seen as a property or characteristic of that item.

For example, in defining the a product-item which is a “car” in traditional database systems, the properties describing the car include things like its make, model, price, colour, engine type AND also how it is organised in the catalogue. So a specific car is defined not only by its physical properties but also by which category/group it belongs to, such as, “motor vehicle” or “transport equipment” or “automobiles” (these are “category-items” for the purpose of the present invention).

“Holden [make], Commodore [model], $25,000 [price], Silver [colour], V6 3.0 litre [Engine Type]” AND “automobile [a sub-category of motor vehicle], motor vehicle [a sub-category of machines], machines [a sub-category of etc . . . ]”.

This approach is restrictive from an item data management point of view because in reality, how or why a product is classified does not change the physical properties or characteristics of that product.

### SUMMARY OF THE INVENTION

In accordance with a first aspect of the present invention there is provided a method of defining the properties of items in an electronic catalogue, the method comprising the steps of associating at least one of a plurality of property set identifiers with each item, wherein each property set identifier is in turn associated with a set of properties, and defining each item utilising the set of properties associated with the property set identifier associated with each item.

An “item” in the context of the present invention may be a “product-item”. That is, it is a particular product, such as a particular car, a particular book, a particular article of clothing, a particular person, organisation, website (basically, anything that requires entry or it would be useful to enter in an electronic catalogue) etc. It may also be a “category-item”, where a category-item is a description of a category or a group to which product-items may belong. It will be appreciated by the skilled person that where a product-item has an ontology (properties which describe the product-item, such as make, model, price, colour of a car), a category-item may also have it's own ontology (i.e. a book may be described whether it is fiction, non-fiction, etc) and in this respect the term “category-item” and “product-item” can in some cases be interchangeable.

Accordingly, the method can provide an electronic catalogue in which items can be defined using different sets of properties for different items. Furthermore, when it is desired to add properties to a particular property set, the method can avoid having to extend the property set of each item of the electronic catalogue. Also, by utilising the associations, extension of a particular property set may not require any hard-coding.

The property set identifier in effect represents an ontology of the item (a set of properties defining the item). Different items in the catalogue may therefore be associated with different ontologies.

Preferably, the method comprises the step of creating a first database table for associating each item with the at least one associated property set identifier.

In one embodiment, the method comprises the step of creating a second database table for associating each of the properties in the sets of properties to the associated property set identifiers.

The same property may belong to more than one set of properties associated with the property set identifiers.

Preferably, the step of defining each item comprises creating a third database table for storing a value for each property of the set of properties associated with the at least one property set identifier associated with each item.

Advantageously, the method can further comprise the step of providing rules for converting the values of properties of one set of properties into corresponding values of properties of another set of properties.

The step of providing the rules advantageously comprises the step of mapping relationships between properties of the one set of properties and properties of the other set of properties. The other set of properties may relate to a different electronic catalogue. Where a definition of properties of items in the different electronic catalogue is not provided in accordance with the first aspect of the present invention defined above, the step of providing the rules preferably comprises extracting the other set of properties and their values from data entries in the different electronic catalogue.

The step of providing the rules may preferably comprise the steps of monitoring a command entered manually by a user of the electronic catalogue during manual conversion of values; requesting confirmation from the user that a particular command should be stored as a rule in a database of the electronic catalogue; and storing the command as the rule in the database.

Where it is desired to convert values of properties, the method can comprise the step of applying at least one of the rules stored in the database to facilitate the transfer.

Preferably, the present invention has the advantage that catalogue data can be created and managed with an unlimited number of ontologies (property sets), and also it allows the customisation, in a non-programmatic way, of these ontologies to cater for different item classes and user needs.

This means that no programming changes are required either to the database structure or at the application program level to create, change or delete ontologies. This is in contrast to traditional systems that have programmatic database constraints on the number of attributes and type of data that can be used to describe product information. When the predefined limited number of data elements is reached, the software program and it's database structure will need programming modifications in order to accommodate the new data requirements.

In accordance with a second aspect of the present invention there is provided an electronic catalogue comprising means for associating at least one of a plurality of property set identifiers with each of a plurality of items of the electronic catalogue, and means for associating each property set identifier with a set of properties; and means for defining each item utilising the set of properties associated with the property set identifier associated with each item.

Preferably, the electronic catalogue comprises a first database table for associating each item with the at least one associated property set identifier.

In one embodiment, the electronic catalogue comprises a second database table for associating each of the properties in the sets of properties to the associated property set identifiers.

The same property may belong to more than one set of properties associated with the property set identifiers.

Preferably, the means for defining each item comprises means for storing a value of each property of the set of properties associated with the at least one property set identifier associated with each item.

In one embodiment, the electronic catalogue comprises a third database table for storing the value of each property of the set of properties associated with the at least one property set identifier associated with each item.

Advantageously, the electronic catalogue can further comprise means for providing rules for converting the values of properties of one set of properties into values of properties of another set of properties.

In one embodiment, the electronic catalogue further comprises means for mapping relationships between properties of the one set of properties and properties of the other set of properties.

The other set of properties can relate to a different electronic catalogue.

In a preferred embodiment, if the different electronic catalogue is not in a form in accordance with the second aspect of the present invention defined above, the electronic catalogue can further comprise means for extracting the other set of properties and their values from data entries in the different electronic catalogue.

The means for providing rules may comprise means for monitoring a command entered manually by the user of the electronic catalogue, in use, during manual conversion of values, means for requesting confirmation from the user that a particular command should be stored as a rule in a database of the electronic catalogue and means for storing the command as the rule in the database.

The electronic catalogue may further comprise means for applying, in use, at least one of the rules stored in the database to facilitate the conversion of values.

In accordance with a third aspect of the present invention there is provided a computer program element comprising computer program code means arranged to instruct a computer for defining the properties of items in an electronic catalogue to associate at least one of a plurality of property set identifiers with each item, wherein each property set identifier is in turn associated with a set of properties, and to define each item utilising the set of properties associated with the property set identifier associated with each item.

In accordance with a fourth aspect of the present invention there is provided a computer readable medium, having a program recorded thereon, wherein the program is arranged to instruct a computer for defining the properties of items in an electronic catalogue to associate at least one of a plurality of property set identifiers with each item, wherein each property set identifier is in turn associated with a set of properties, and to define each item utilising the set of properties associated with the property set identifier associated with each item.

In accordance with a fifth aspect of the present invention, there is provided there is provided a tool for constructing a system for implementing the method of the first aspect of the present invention discussed above.

Preferably, the tool includes software instructions for instructing a computing system to implement the system.

In accordance with a sixth aspect of the present invention, there is provided a tool for constructing an electronic catalogue in accordance with the second aspect of the present invention.

Preferably, the tool includes software instructions for instructing a computing system to construct the electronic catalogue.

Preferred forms of the invention will now be described, by way of example only, with reference to the accompanying drawings, in which:

### BRIEF DESCRIPTION OF THE DRAWINGS

FIG. 1 is a schematic drawing illustrating a prior art table system of a prior art electronic catalogue.

FIG. 2 is a schematic drawing illustrating an electronic catalogue embodying the present invention.

FIG. 3 is a schematic drawing illustrating corporation of electronic catalogues embodying the present invention.

### DETAILED DESCRIPTION OF THE PREFERRED EMBODIMENT

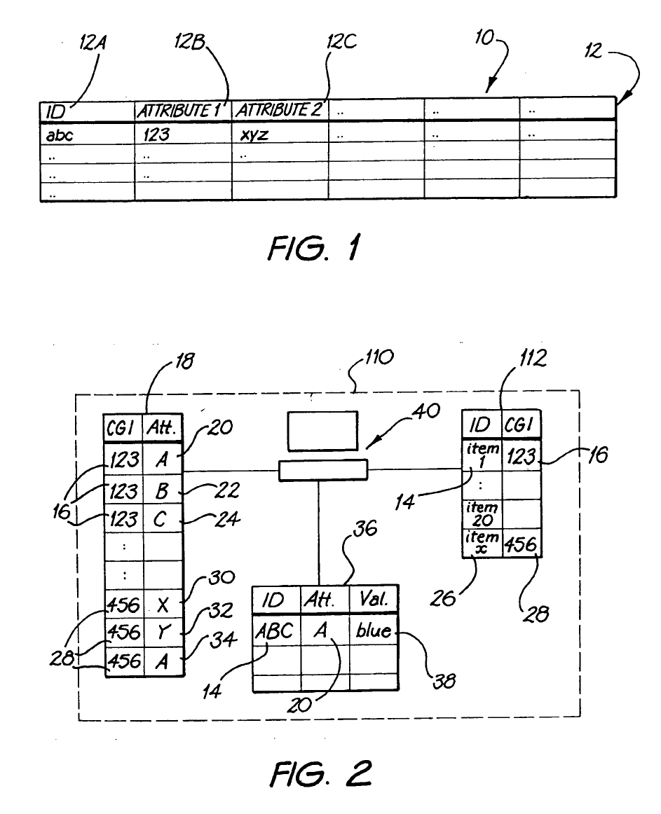

As discussed in the preamble, in traditional prior art systems, item information is stored in data tables that have a pre-defined number of columns, each of which can be assigned to describe a particular property (attribute) of the item. FIG. 1 illustrates a schematic example of a standard database table for providing information (attributes 12B, 12C, etc) on items 12A.

For example:

If a system has 10 columns in its item table, then it can have up to 10 data elements that can be used to define item-characteristics like:

1. Catalogue_Number; 2. Product_Short_Name; 3. Product_Description; 4. Retail_Price; 5. Wholesale_Price; 6. Unit_of_Measure; 7. Pack_Size; 8. Product_Image; 9. Size; 10. Colour

If the user requires addition of data elements to describe the products, such as, Length, Height, Width, Weight, Handling Instructions etc. the system will have to be re-programmed, or

If the user has different classes or types of products that have different characteristics, such as, Material Cost; Freight Cost; Tax; GST etc. then new tables or more data elements need to be added to the existing table, which involves re-programming effort.

For example:

If a retailer sells books, CDs, shirts and confectionery, the data elements that describe these different item classes may be:

| | |
|---|---|
| BOOKS: | ISBN, Author, Title, RRPrice, Number of Pages, |
| | Year Published; Publisher; Language: Edition; |
| | UOM |
| CDs: | Catalogue Number, Artist, Album Title, RRPrice, |
| | Number of Tracks; Year Released; Record |
| | Company; Language; volume; UOM |
| SHIRTS: | Label, Designer, Article Name, RRPrice, Style; |
| | Cut; Colour; Season; Material 1; Material2; |
| | Care Instructions; Ironing Instruction; Size |
| | Chest; Size Collar; UOM |
| CANDY: | Brand, Type, Article Name, RRPrice, Colour; |
| | Ingredients 1; Ingredients 2 - etc; Serving |
| | Instruction; Pack Size; Gross Weight; Net |
| | Weight; UOM; Use By Date |

The above example illustrates that, to cater for the description of different product classes, traditional systems will need to be pre-defined with either one large database table that has hundreds of columns (one table with all the data elements combined) or many smaller database tables, one for each product type with only those data elements relevant for the product type (that is, a BOOKS table, CDs table, SHIRTS table, CANDY table). In either case the maintenance of product data becomes highly complex, cumbersome and slow. Furthermore, the data elements can not be grouped or re-grouped without programming changes to the system or database as old products classes or phased-out and new ones phased-in. Note also, that there may also be duplication of data elements (such as RRPrice, UOM).

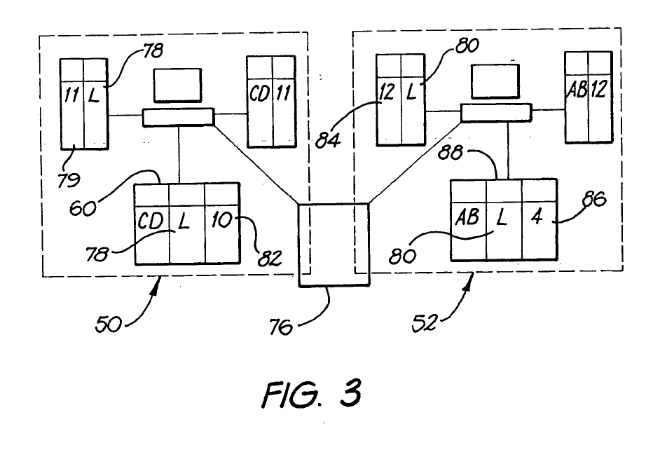

A description of an embodiment of the present invention will now be given with respect to FIGS. 2 and 3.

In FIG. 2, an electronic catalogue 110 of the preferred embodiment of the present invention comprises a first database table 112 in which particular items e.g. 14 are associated with their respective property set identifiers, e.g. 16.

The electronic catalogue 10 also comprises a second database table 18 in which a set of properties, e.g. 20, 22 and 24 are associated with property set identifiers, e.g. 16.

It will be appreciated by a person skilled in the art that by way of provision of the first database table 112 and the second database table 18, a multitude of property sets having different sets of properties associated with them can be incorporated into the electronic catalogue 110, without having to change the hard-coding (i.e. the column headings) of the database tables 12 and 18.

If a new item 26 is to be added to the electronic catalogue, for which none of the previous property set is suitable, a new property set identifier 28 is added in the database table 112. At the same time, a new set of properties 30, 32 and 34 are associated with the new property set identifier 28 in the second database table 18.

It is noted here that the same property can belong to different sets of properties associated with respective ones of the property set identifiers, see e.g. property 20, 34.

The electronic catalogue 110 further comprises a third database table 36 in which the actual values, e.g. 38 of properties e.g. 20 of a particular item e.g. 14 are stored.

Editing of data in the electronic catalogue 110 is facilitated through a user interface in the form of a desk top computer 40. It will be appreciated by a person skilled in the art that the addition of items and/or property sets in the above described embodiment does not require any hard coding to effect changes in the various database tables 112, 18 and 36. Rather, the addition of data simply requires entering of data into the existing, hard coded database tables 112, 18 and 36. Accordingly, this is a task which does not require specific programming skills. This makes the editing of the electronic catalogue 110 easy and cost effective.

With the present invention, therefore, different ontologies “templates” can easily be created for new item classes without programmatic changes.

In the example of FIG. 2, item classes will be associated with the same ontology (property set). For example items 1 through 20 may all be cars. The associated property set identifier 123 may include a property set which includes colour (A), engine size (B) car type (e.g. saloon, sports car, etc, data element C). Any item class “car” associated with property set identifier 123 will have the same ontology. This ontology can be added to by adjusting table 18 to add in another data element in addition to data elements 20(A), 22(B) and 24(C). This is a simple matter of adding the data element and associating it with the same property set identifier 123. The appropriate value for the data element is inserted in table 36, against the appropriate item.

All items of the same class can be accessed via the property set identifier. The ontology can be extended by manipulating table 18.

Items of different classes can be included in the table 112. Any items may be included, e.g. cars, books, clothes, etc, all in the same table. Different data classes can be associated with different ontologies (property sets). The number of ontologies that can be supported is basically unlimited.

Another feature of the present invention is that different ontologies can be defined for the same item classes, the ontologies being user defined to customise data elements that are visible to particular users i.e. what “perspective” a particular user has. For example, what information a user is able to view may depend on a particular security level i.e. the higher security level, the more information that a particular user is able to view. Particular users, therefore, may only be able to utilise particular ontologies for particular item classes. Each user may have a different “perspectives”. This can easily be handled with the present invention by defining different ontologies for different item classes associated with different user perspectives.

In more detail, in the present invention, without requiring programming changes (hard coding, changing of columns of the database) there is no limit on:

The number of data elements (or attributes) that can be defined

The number of ontologies that can be defined

How the user can use these ontologies to customise the data elements that are visible for every product item and to every user (in “perspectives”)

Following from the above example:

The user simply adds new data elements when required:

ISBN, Author, Title, RRPrice, Number of Pages, Year Published; Publisher; Language; Edition; UOM; Catalogue Number; Artist, Album Title, Number of Tracks; Year Released; Record Company; Language; Volume; Label; Designer; Article Name; Style; Cut; Colour; Season; Material 1; Material 2; Care Instructions; Ironing Instruction; Size Chest; Size Collar; Brand, Type, Article Name, Colour; Ingredients 1; Ingredients 2 etc; Serving Instruction, Pack Size; Gross Weight; Net Weight; Use By Date

These data elements can then be “assembled” into a template called an “ontology” for each product class, for instance:

BOOKS ontology has data elements: ISBN, Author, Title, RRPrice, Number of Pages, Year Published; Publisher; Language; Edition; UOM

CDs ontology has data elements: Catalogue Number; Artist, Album Title, Number of Tracks; Year Released; Record Company; Language; Volume; UOM

SHIRTS ontology has data elements: Label; Designer; Article Name; Wholesale Price; First Cost; Packaging Cost; Freight Cost; RRPrice; Promotion Price; Style; Cut; Colour; Season; Material 1; Material 2; Care Instructions; Ironing Instruction; Size Chest; Size Collar; UOM

CANDY ontology has data elements: Brand; Type; Article Name, RRPrice; Colour; Ingredients 1; Ingredients 2 etc; Serving Instruction, Pack Size; Gross Weight; Net Weight; UOM, Use By Date

Additionally, when new product classes are required, new data elements can be added and new ontology templates can be created using any data element from the list of user-defined elements.

Another application of this is to create different ontologies to control the amount of product information that different users can see in their ‘perspective’ of the catalogue.

For example:

For shirts, the catalogue manager can create different SHIRTS ontologies for different users such as, customers, suppliers, accounting staff, sales staff etc.

SHIRTS ontology has data elements: Label; Designer: Article Name; Wholesale Price; First Cost; Packaging Cost; Freight Cost; RRPrice; Promotion Price; Style; Cut; Colour; Season; Material 1; Material 2; Care Instructions; Ironing Instruction; Size Chest; Size Collar; UOM

SHIRTS ontology for Customer 1 has data elements: Label; Designer; Article Name; RRPrice; Style; Cut; Colour; Season; Material 1; Material 2; Care Instructions; Ironing Instruction; Size Chest; Size Collar; UOM

SHIRTS ontology for Customer 2 has data elements: Label; Designer; Promotion Price; Style; Cut; Colour; Season; Material 1; Care Instructions; Ironing Instruction; Size Chest; Size Collar; UOM.

SHIRTS ontology for Accounting Staff has data elements: Label; Designer; Article Name; Wholesale Price; First Cost; Packaging Cost; Freight Cost; RRPrice; Style; Cut; Colour; Season; Size Chest; Size Collar; UOM

SHIRTS ontology for Sales staff has data elements: Label; Designer; Article Name; RRPrice; Promotion Price; Style; Cut; Colour; Season; Material 1; Material 2; Care Instructions; Ironing Instruction; Size Chest; Size Collar; UOM.

Turning now to FIG. 3, there are shown two separate electronic catalogues 50, 52. Each of the catalogues 50, 52 is substantially structured in the same way as the electronic catalogue 110 of FIG. 2 described above.

In the following, different scenarios for transferring items or groups of items between the electronic catalogues 50, 52 will be described.

Firstly, if an identical property set exists in catalogue 52 to the one to which the item to be transferred from catalogue 50 belongs, the transfer is a matter of copying the relevant data from the database table 60 of catalogue 50, in which the actual values of properties are stored for the particular items (compare database table 36 of FIG. 2).

Alternatively, should an identical property set exist in catalogue 52 but a different property set identifier is being used, the transfer will require execution of a rule: All items of the catalogue 50 having property set identifier 246 should be transferred into catalogue 52 with the property set identifier being changed to 789, which is the property set identifier in catalogue 52 which is associated with an identical set of properties as used for those items in catalogue 50.

This rule, which is initially manually entered by a user of the catalogue 52 is subsequently stored in a rule database 76. The rule database 76 is accessible by both catalogues 52 and 50. Any future transfer can utilise prior rules established by different users. The rule database 76 is arranged to notify a future user upon entering of a particular transfer request if a rule is already stored in the rule database 76 for a corresponding previous request. The rule database 76 is further arranged to apply the stored rule automatically in executing the new transfer request.

The rule database 76 further comprises means for generating “reverse” rules for transfer in an opposing direction between the catalogues 52, 50 on the basis of a transfer rule created manually for transfer in one particular direction.

It will be appreciated by a person skilled in the art that the principle of rule-based transfer of data described above also applies to a scenario where it is desired to transfer data between the catalogues 50, 52 where certain values need to be changed due to differences in the properties associated with a particular property set identifier.

This will also involve the mapping of relations between properties of the catalogues 50, 52.

For example, if a length property 78 of a classification group 79 in catalogue 50 is in centimetres whilst the length property 80 of a corresponding property set in catalogue 52 is in inches, a transfer rule would have to be applied in which the value 82 is converted into inches during transfer into a value 86 in database table 88 of catalogue 52. It will be appreciated that conversion of certain values of properties would in that case be favourable rather than creating an entirely new property set in catalogue 52, which would be the easier transfer. This is because it would be advantageous to keep items which should belong into the same property set by their nature together in the same property set.

Different examples of where applying rules to conform the transferred data is preferable over simply adding the data “as received” from another database table include where properties are identified by different names but their meaning is the same. This may be due e.g. simply because of different spelling in different languages, such as colour versus colour.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, in the embodiment described in FIG. 3, if one of the electronic catalogues was not in a form embodying the present invention, the other electronic catalogue could further comprise means for extracting properties and their values from data entries of the other electronic catalogue. The extraction in turn could be facilitated by rules stored in a further database table. Accordingly, an intelligent electronic catalogue system can be provided which can be made a tool for accessing information from a large variety of electronic catalogues through a single user interface.

It will be appreciated by a person skilled in the art that the arrangement disclosed in the description and figures can be used very flexibly.

For example table 18 of FIG. 3 establishes the relationship between ontologies and their properties (or attributes). Table 112 establishes the relationship between an item (whether that is a product-item or a category-item) and it's ontologies. Table 36 associates the values to the attributes of each item.

Therefore, table 18 allows a user (typically a catalogue manager) to create and maintain ontologies;

Table 112 allows a user to create (includes importing), maintain and view all items (all classes of items) through different ontologies (which are really customisation templates), and table 36 defines the values for all the attributes that are associated with an individual item.

By combining the three tables a user can create different templates (ontologies) that control how much details (attributes and values of an item) that a user can see. These templates (ontologies) can be applied for different item classes (or within the same item class, different degrees of information detail-perspective, for example, an accountant can see cost information for products that a receptionist can't).

With the present invention a tool, preferably a software tool, is provided to enable a person to construct the electronic catalogue described above on a computing system. This, as will be appreciated by a skilled person, can be developed from the above description of the electronic catalogue.

In the above description and in the following claims the term “electronic catalogue” should be taken to mean any catalogue or database which can be implemented by a computing system, and, as computing systems develop into the future this is not necessarily limited to electronic computing systems.

In the above description, databases have been represented as tables, having columns and rows. It will be appreciated that this is a representation only that can be easily understood by humans, and in a computing system the data may be stored in any format, not necessarily in a table structure.

The term “electronic catalogue” has been used throughout this description. The present invention has general application, not just to electronic catalogues, but general application for the management of data and integration. Other applications are managing directories of people and company's details (such as names and addresses in the phone directory). A further application could be the integration and sharing of data between business systems (such as ERP, CRM and other legacy systems). A fourth application could be the management of electronic documents (for example, medical records or web pages). The term electronic-catalogue should be considered to be used very broadly in this context therefore, to cover any data management and integration application.

It will be appreciated by a person skilled in the art the electronic catalogue of the present invention may be implemented on any computing system, whether a desktop or a network computing system, or any other type of computing system.

In the claims that follow and in the summary of the invention, except where the context requires otherwise due to express language or necessary implication, the word “comprising” is used in the sense of “including”, i.e. the features specified may be associated with further features in various embodiments of the invention.

The claims defining the invention are as follows:

1. A method of defining the properties of items in an electronic catalogue, the method comprising the steps of:
associating at least one of a plurality of property set identifiers with each item, wherein each property set identifier is in turn associated with a set of properties; and
defining each item utilising the set of properties associated with the property set identifier associated with each item.

2. A method as claimed in claim 1, wherein the method comprises the step of creating a first database table for associating each item with the at least one associated property set identifier.

3. A method as claimed in claims 1 or 2, wherein the method comprises the step of creating a second database table for associating each of the properties in the sets of properties to the associated property set identifiers.

4. A method as claimed in any one of the preceding claims, wherein one of the properties belongs to more than one set of properties associated with the property set identifiers.

5. A method as claimed in any one of the preceding claims, wherein the step of defining each item comprises creating a third database table for storing a value for each property of the set of properties associated with the at least one property set identifier associated with each item.

6. A method as claimed in any one of the preceding claims, wherein the method further comprises the step of providing rules for converting the values of properties of one set of properties into corresponding values of properties of another set of properties.

7. A method as claimed in claim 6, wherein the method further comprises the step of mapping relationships between properties of the one set of properties and properties of the other set of properties.

8. A method as claimed in claim 6 or 7, wherein the other set of properties relates to a different electronic catalogue.

9. A method as claimed in claim 8, wherein, if a definition of properties of items in the different electronic catalogue is not provided in accordance with the method as defined in claim 1, the step of providing the rules preferably comprises extracting the other set of properties and their values from data entries in the different electronic catalogue.

10. A method as claimed in any one of claims 6 to 8, wherein the step of providing the rules comprises the steps of:
monitoring a command entered manually by a user of the electronic catalogue during manual transferring of values;
requesting confirmation from the user that a particular command should be stored as a rule in a database of the electronic catalogue; and
storing the command as the rule in the database.

11. A method as claimed in claim 10, wherein the method comprises the step of applying at least one of the rules stored in the database to facilitate the transfer.

12. A method in accordance with any one of the preceding claims, comprising the step of associating a plurality of property set identifiers with each item, each property set identifier being associated with a different set of properties, and comprising the further step of selecting access to a particular property set identifier depending on user perspective.

13. An electronic catalogue comprising:
means for associating at least one of a plurality of property set identifiers with each of a plurality of items of the electronic catalogue;
means for associating each property set identifier with a set of properties; and
means for defining each item utilising the set of properties associated with the property set identifier associated with each item.

14. An electronic catalogue as claimed in claim 13, wherein the electronic catalogue comprises a first database table for associating each item with the at least one associated property set identifier.

15. An electronic catalogue as claimed in claims 13 or 14, wherein the electronic catalogue comprises a second database table for associating each of the properties in the sets of properties to the associated property set identifiers.

16. An electronic catalogue as claimed in any one of claims 13 to 15, wherein one of the properties belongs to more than one set of properties associated with the property set identifiers.

17. An electronic catalogue as claimed in any one of claims 13 to 16, wherein the means for defining each item comprises means for storing a value of each property of the set of properties associated with the at least one property set identifier associated with each item.

18. An electronic catalogue as claimed in any one of claims 13 to 16, wherein the electronic catalogue comprises a third database table for storing the value of each property of the set of properties associated with the at least one property set identifier associated with each item.

19. An electronic catalogue as claimed in any one of claims 13 to 18, wherein the electronic catalogue further comprises means for providing rules for converting the values of properties of one set of properties associated with one of the property set identifiers into values of properties of a different set of properties associated with a different property set identifier.

20. An electronic catalogue as claimed in claim 19, further comprising means for mapping relationships between properties of the one set of properties and properties of the other set of properties.

21. An electronic catalogue as claimed in claims 19 or 20, wherein the other property set relates to a different electronic catalogue.

22. An electronic catalogue as claimed in claim 21, wherein, if the different electronic catalogue is not of a form as defined in claim 1, the electronic catalogue further comprises means for extracting the other set of properties and their values from data entries in the different electronic catalogue.

23. An electronic catalogue as claimed in claims 19 to 22, wherein the electronic catalogue further comprises:
means for monitoring a command entered manually by the user of the electronic catalogue, in use, during manual transferring of values;
means for requesting confirmation from the user that a particular command should be stored as a rule in a database of the electronic catalogue; and
means for storing the command as the rule in the database.

24. An electronic catalogue as claimed in any one of claims 19 to 23, wherein the electronic catalogue further comprises means for applying, in use, at least one of the rules stored in the database to facilitate the transfer of values.

25. An electronic catalogue as claimed in any one of claims 13 through 24, wherein the means for associating at least one of the plurality of property set identifiers with each of the plurality of items in the electronic catalogue, is arranged to associate a plurality of property set identifiers with one or more items of the electronic catalogue, and there is further provided means for determining user access to the property set identifiers for the items depending upon user perspective, whereby a user may have access to only a predetermined property set identifier for each item.

26. A computer program element comprising computer program code means arranged to instruct a computer for defining the properties of items in an electronic catalogue to:
associate at least one of a plurality of property set identifiers with each item, wherein each property set identifier is in turn associated with a set of properties; and
to classify each item utilising the set of properties associated with the property set identifier associated with each item.

27. A computer readable medium, having a program recorded thereon, wherein the program is arranged to instruct a computer for defining the properties of items in an electronic catalogue to:
associate at least one of a plurality of property set identifiers with each item, wherein each property set identifier is in turn associated with a set of properties; and
to classify each item utilising the set of properties associated with the property set identifier associated with each item.

28. A tool for constructing a system for implementing the method of any one of claims 1 to 12.

29. A tool for constructing an electronic catalogue in accordance with any one of claims 13 to 25.
